(19) United States
(12) Patent Application Publication
(10) Pub. No.: US 2015/0278496 A1
(43) Pub. Date: Oct. 1, 2015

(54) METHOD, DEVICE AND SYSTEM FOR IDENTITY VERIFICATION

(71) Applicant: TENCENT TECHNOLOGY (SHENZHEN) COMPANY LIMITED, Shenzhen, Guangdong (CN)

(72) Inventors: Wanxin Wang, Shenzhen City (CN); Ruilin Ma, Shenzhen City (CN)

(21) Appl. No.: 14/379,814

(22) PCT Filed: Dec. 20, 2013
(86) PCT No.: PCT/CN2013/090081

§ 371 Date: Aug. 20, 2014

(30) Foreign Application Priority Data
May 29, 2013 (CN) 201310207464.5

(51) Int. Cl. G06F 21/32; G06F 17/27; G10L 17/06

(52) U.S. Cl. CPC G06F 21/32; G10L 17/06; G06F 17/2785

(57) ABSTRACT

Provided is a method for identity verification that includes receiving an access request, generating a corresponding verification code and returning the verification code. The method acquires voiceprint information and semantic information corresponding to the access request. Then executes an identity verification according to the voiceprint information and semantic information.

### CROSS-REFERENCE TO RELATED APPLICATIONS

This application is a U.S. National Phase application submitted under 35 U.S.C. §371 of Patent Cooperation Treaty application serial no. PCT/CN2013/090081 filed Dec. 20, 2013, and entitled METHOD, DEVICE AND SYSTEM FOR IDENTITY VERIFICATION, which application claims priority to Chinese patent application serial no. CN 201310207464.5, filed May 29, 2013, and entitled [symbol] , which are incorporated herein by reference.

### TECHNICAL FIELD

The present disclosure relates to the field of internet technology, and more particularly to a method, a device and a system for identity verification.

### BACKGROUND

When adopting e-bank for payments or logging in an internet application, usually a user first needs to execute identity verification. The user needs to input an account number, a corresponding password and a prompted verification code in a web page, and then submits the information so as to complete identity verification.

### SUMMARY

In one aspect, the present disclosure provides a method for identity verification which is capable of improving operation convenience.

A method for identity verification includes:
receiving an access request, generating a corresponding verification code and returning the verification code;
acquiring voiceprint information and semantic information corresponding to the access request, and the semantic information corresponds to the verification code; and
executing identity verification according to the voiceprint information and semantic information.

In another aspect, the present disclosure provides a device for identity verification which is capable of improving operation convenience.

A device for identity verification includes:
a verification code return module, configured to receive an access request, generate a corresponding verification code and return the verification code;
a feature extraction module, configured to acquire voiceprint information and semantic information corresponding to the access request, and the semantic information corresponds to the verification code; and
an identity verification module, configured to execute identity verification according to the voiceprint information and semantic information.

In another aspect, the present disclosure provides a method for identity verification which is capable of improving operation convenience.

A method for identity verification, implemented in a server and a client terminal, includes:
receiving, by the server, an access request sent from the client terminal, generating a corresponding verification code and returning the verification code;
acquiring, by the client terminal, a voice segment input by a user, obtaining voiceprint information and semantic information of the voice segment by calculation, generating an identity verification request according to the voiceprint information and semantic information, and sending the identity verification request to the server; and
receiving, by the server, the identity verification request, extracting voiceprint information and semantic information according to the identity verification request, and executing identity verification according to the voiceprint information and semantic information.

In another aspect, the present disclosure provides a system for identity verification which is capable of improving operation convenience.

A system for identity verification includes a server and a client terminal, wherein, the server is configured to receive an access request sent from the client terminal, and then generate a corresponding verification code and return the verification code;
the client terminal is configured to acquire a voice segment input by a user, obtain voiceprint information and semantic information of the voice segment by calculation, generate an identity verification request according to the voiceprint information and semantic information, and send the identity verification request to the server; and
the server is also configured to receive the identity verification request, extract voiceprint information and semantic information according to the identity verification request, and execute identity verification according to the voiceprint information and semantic information.

According to the method, device and system for identity verification of the present disclosure, when executing identity verification, the user simply needs to dictate the content shown in the verification code in order to complete the operation of inputting, without the need of inputting a password or a verification code. As compared with the prior art solution, the present disclosure reduces the operation steps for inputting when the user executes identity verification, thereby improving operation convenience.

### BRIEF DESCRIPTION OF THE DRAWINGS

FIG. 1 is a flow diagram illustrating the method for identity verification according to one embodiment of the present invention;

FIG. 2 is a structure diagram illustrating the device for identity verification according to one embodiment of the present invention;

FIG. 3 is a structure diagram illustrating the device for identity verification according to another embodiment of the present invention;

FIG. 4 is a flow diagram illustrating the method for identity verification according to another embodiment of the present invention;

FIG. 5 is a structure diagram illustrating the system for identity verification according to one embodiment of the present invention.

### DETAILED DESCRIPTION

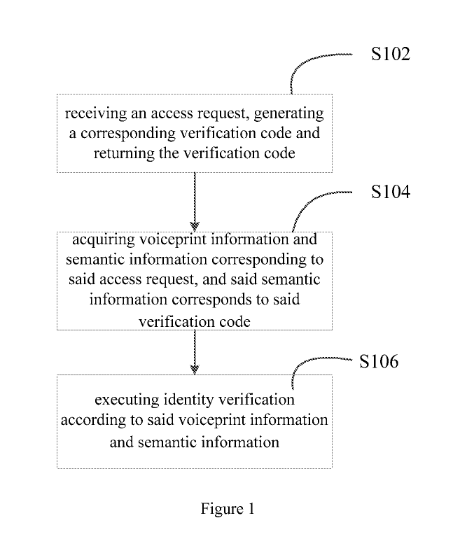

In one embodiment as shown in FIG. 1, a method for identity verification is provided; the method entirely depends on computer programs, and can be implemented in a Von Neumann computer system, the computer system may be a remote server for identity verification, or may be a local terminal. The method includes:
S102, receiving an access request, generating a corresponding verification code and returning the verification code.

The access request refers to a request for accessing certain resources such as a webpage, a folder, runtime memory area of a desktop application, and so on.

For example, in an application scenario, wherein the method is implemented in a web server, a user may access the web server through a browser. When logging in a forum website and posting a thread, the user first needs to access the login page of the forum website. After receiving a request for accessing the login page, the web server of the forum website generates a verification code and returns the verification code to the browser.

In another application scenario, wherein the method is implemented in a local terminal, when using a local identity (such as an account number of windows operating system) for logging in a local running desktop application, the user first needs to access the login interface of the desktop application. And then the desktop application generates a verification code and shows the verification code in the login interface.

S104, acquiring voiceprint information and semantic information corresponding to the access request, and the semantic information corresponds to the verification code.

The voiceprint information refers to the voiceprint feature data calculated according to voice data. The semantic information refers to the character string information, representing the meaning of voice data, acquired by means of recognizing the voice data.

In an application scenario, wherein the method is implemented in a web server, a user needs to dictate a piece of voice corresponding to the content of the verification code via an audio-input device such as a voice tube, a microphone, and so on. A browser collects a voice segment of the piece of voice, generates an identity verification request according to the voice segment, and sends the request to the web server. The identity verification request and access request share the same session. In another application scenario, wherein the method is implemented in a local terminal, the user also needs to dictate a piece of voice corresponding to the content of the verification code via an audio-input device such as a voice tube, a microphone, and so on. The local terminal collects a voice segment of the piece of voice so as to obtain voiceprint information and semantic information corresponding to the access request.

In one embodiment, the method is implemented in a web server, a browser or a client terminal of an internet application that first collects a voice segment input by a user, then locally extracts corresponding voiceprint information and semantic information, and then generates a corresponding identity verification request. In this embodiment, after receiving the identity verification request, the web server is capable of extracting voiceprint information and semantic information contained in the request directly.

For example, in an application scenario, wherein the method is implemented in a remote server, a browser or a client terminal of an internet application calculates voiceprint information and semantic information of the voice segment according to the collected voice segment, then generates an identity verification request according to the voiceprint information and semantic information, and sends the identity verification request to the remote server. After receiving the identity verification request, the remote server extracts voiceprint information and semantic information therefrom.

Since the data volume of the voice segment is larger, the terminal calculates with the voice segment so as to acquire voiceprint information and semantic information (the data volume of which is smaller), so that the data volume to be transmitted will be reduced, and bandwidth is conserved.

In another embodiment, the terminal is capable of encapsulating the collected voice segment into an identity verification request directly. The remote server is capable of extracting the voice segment according to the identity verification request received, and obtains the voiceprint information and semantic information by means of calculating with the voice segment.

In an application scenario, wherein the method is implemented in a local terminal, a desktop application is capable of acquiring a voice segment input by a user, and then calculating voiceprint information and semantic information according to the voice segment. In an application scenario, wherein the method is implemented in a web server, since the method of processing the voice segment through adding codes in the browser will affect the running speed of the browser, causing a worse user experience, the present disclosure provides another method of acquiring the input voice segment by tools such as flash plug-in of the browser, and so on, and then sending the voice segment to the web server, thereby improving the running speed of the browser.

S106, executing identity verification according to the voiceprint information and semantic information.

In one embodiment, prior to executing identity verification, a user needs to execute registration, and a method for registration includes:
acquiring a registration request; extracting a voice segment contained in the registration request; calculating voiceprint feature codes of the voice segment, and saving the voiceprint feature into a voiceprint database.

In this embodiment, the step of executing identity verification according to the voiceprint information and semantic information may include:
querying the voiceprint database whether there is voiceprint feature code matching with the voiceprint information, and judging whether the semantic information matches with the verification code; if the voiceprint database contains the voiceprint feature code and the semantic information matches with the verification code, the request passes identity verification.

In an application scenario corresponding to this embodiment, if a user is willing to join a social network website and post a thread, the user can execute the operation of registration by inputting a voice segment. After the registration is completed successfully, the voiceprint feature codes corresponding to the voice segment is saved in a voiceprint database. When logging in afterwards, the user can execute the operation of login through dictating the verification codes shown in the login page. If the voiceprint database contains the voiceprint information of the voice segment orally input by the user, the user will pass the identity verification, and log in successfully. After logging in, the social network website can randomly allocate a user identification (such as a nickname, and so on) to distinguish among users.

In one embodiment, a user identification corresponding to the access request can be acquired. The user identification may be extracted from the received identity verification request containing the voiceprint information and semantic information, or may be extracted from a session corresponding to the access request.

In this embodiment, the step of executing identity verification according to the voiceprint information and semantic information includes: querying for an voiceprint feature code corresponding to the user identification; judging whether the extracted voiceprint information matches with the voiceprint feature code, and judging whether the semantic information matches with the verification code, and if both judging results are matching, the request passes identity verification.

In this embodiment, when executing an operation of registration, the user may input the user identification at the same time. The foregoing method for registration further includes:
extracting a user identification according to the registration request, and establishing a corresponding relationship between the user identification and voiceprint feature code.

When logging in, the user needs to input the user identification along with the account number, and the client terminal can add the user identification into the launched identity verification request. After receiving the identity verification request, the remote server can first extract the user identification, then acquire voiceprint feature code corresponding to the user identification, and then match the voiceprint feature code with the voiceprint information contained in the identity verification request. If the voiceprint feature code matches with the voiceprint information successfully, and the semantic information contained in the login request matches with the verification code, the user passes identity verification and logs in successfully.

In one embodiment, the method for registration further includes steps of establishing a corresponding relationship between the voice segment extracted from a registration request and the voiceprint feature code acquired by calculation, and saving the voice segment.

The voice segment input by the user at registration is saved, and when the voiceprint calculation algorithms is updated, the saved voice segment can be used for recalculation with the updated voiceprint calculation algorithms, and the voiceprint feature code corresponding to the voice segment contained in the voiceprint database is updated according to the calculation result, so that the update of the voiceprint calculation algorithms will not affect existing registration data, thereby improving the reliability of data.

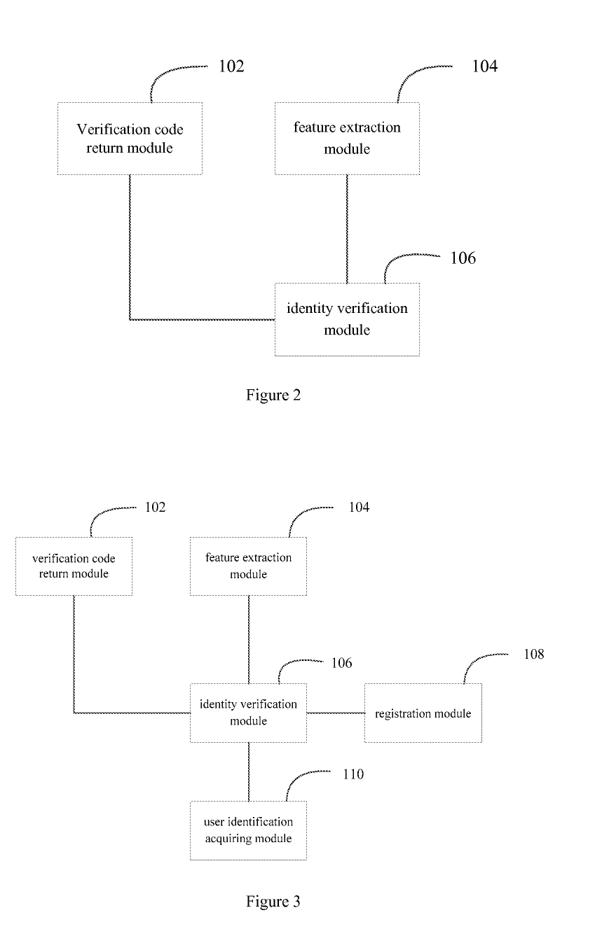

In one embodiment as shown in FIG. 2, a device for identity verification is provided, including a verification code return module 102, a feature extraction module 104 and an identity verification module 106.

The verification code return module 102 is configured to receive an access request, generate a corresponding verification code and return the verification code.

The access request refers to a request for accessing certain resources such as a webpage, a folder, runtime memory area of a desktop application, and so on.

For example, in an application scenario based on a web server, a user may access the web server through a browser. When logging in a forum website and posting a thread, the user first needs to access the login page of the forum website. After receiving a request for accessing the login page, the web server of the forum website generates a verification code and returns the verification code to the browser.

In another application scenario based on a local terminal, when using a local identity (such as an account number of windows operating system) for logging in a local running desktop application, the user first needs to access the login interface of the desktop application. And then the desktop application generates a verification code and shows the verification code in the login interface.

The feature extraction module 104 is configured to acquire voiceprint information and semantic information corresponding to the access request, and the semantic information corresponds to the verification code.

The voiceprint information refers to the voiceprint feature data calculated according to voice data. The semantic information refers to the character string information, representing the meaning of voice data, acquired by means of recognizing the voice data.

In an application scenario based on a web server, a user needs to dictate a piece of voice corresponding to the content of the verification code via an audio-input device such as a voice tube, a microphone, and so on. A browser collects a voice segment of the piece of voice and according to the voice segment, generates an identity verification request and sends the request to the web server. The identity verification request and access request share the same session. In another application scenario based on a local terminal, the user also needs to dictate a piece of voice corresponding to the content of the verification code via an audio-input device such as a voice tube, a microphone, and so on. The local terminal collects a voice segment of the piece of voice so as to obtain voiceprint information and semantic information corresponding to the access request.

In one embodiment, the device for identity verification is based on a web server, a browser or a client terminal of an internet application first collects a voice segment input by a user, then locally extracts corresponding voiceprint information and semantic information, and generates a corresponding identity verification request. In this embodiment, the feature extraction module 104 is capable of extracting voiceprint information and semantic information contained in the request directly.

For example, in an application scenario based on a remote server, a browser or a client terminal of an internet application calculates voiceprint information and semantic information of the voice segment according to the collected voice segment, then generates an identity verification request according to the voiceprint information and semantic information, and sends the identity verification request to the remote server. After receiving the identity verification request, the remote server extracts voiceprint information and semantic information therefrom.

Since the data volume of the voice segment is larger, the terminal calculates with the voice segment so as to acquire voiceprint information and semantic information (the data volume of which is smaller), so that the data volume to be transmitted will be reduced, and bandwidth is conserved.

In another embodiment, the terminal is capable of encapsulating the collected voice segment into an identity verification request directly. The remote server is capable of extracting the voice segment according to the identity verification request received, and obtaining the voiceprint information and semantic information by means of calculating with the voice segment.

In an application scenario based on a local terminal, a desktop application is capable of acquiring a voice segment input by a user, and then calculating voiceprint information and semantic information according to the voice segment. In an application scenario based on a web server, since the method of processing the voice segment through adding codes in the browser will affect the running speed of the browser, causing a worse user experience, the present disclosure provides another method of acquiring the input voice segment by tools such as flash plug-in of the browser, and so on, and then sending the voice segment to the web server, thereby improving the running speed of the browser.

The identity verification module 106 is configured to execute identity verification according to the voiceprint information and semantic information.

In one embodiment, prior to executing identity verification, a user needs to execute registration. As shown in FIG. 3, the identity verification 106 further includes a registration module 108, configured to acquire a registration request, extract a voice segment contained in the registration request, calculate voiceprint feature codes of the voice segment, and save the voiceprint feature into a voiceprint database.

In this embodiment, the identity verification module 106 is capable of querying the voiceprint database whether there is voiceprint feature code matching with the voiceprint information, and judging whether the semantic information matches with the verification code; if the voiceprint database contains the voiceprint feature code and the semantic information matches with the verification code, the request passes identity verification.

In an application scenario corresponding to this embodiment, if a user is willing to join a social network website and post a thread, the user can execute the operation of registration by inputting a voice segment. After the registration is completed successfully, the voiceprint feature codes corresponding to the voice segment is saved in a voiceprint database. When logging in afterwards, the user can execute the operation of login through dictating the verification codes shown in the login page. If the voiceprint database contains the voiceprint information of the voice segment orally input by the user, the user will pass the identity verification, and log in successfully. After logging in, the social network website can randomly allocate a user identification (such as a nickname, and so on) to distinguish among users.

In one embodiment as shown in FIG. 3, the device for identity verification further includes a user identification acquiring module 110, configured to acquire the user identification corresponding to the access request. The user identification module 110 may be configured to extract the user identification from the received identity verification request containing the voiceprint information and semantic information, or may be configured to extract the user identification from a session corresponding to the access request.

In this embodiment, the identity verification module 106 is further capable of querying for an voiceprint feature code corresponding to the user identification; judging whether the extracted voiceprint information matches with the voiceprint feature code, and judging whether the semantic information matches with the verification code, and if both judging results are matching, the request passes identity verification.

In this embodiment, when executing an operation of registration, the user may input the user identification at the same time. The registration module 108 is further capable of extracting a user identification according to the registration request, and establishing a corresponding relationship between the user identification and voiceprint feature code.

When logging in, the user needs to input the user identification along with the account number, and the client terminal can add the user identification into the launched identity verification request. After receiving the identity verification request, the remote server can first extract the user identification, then acquire voiceprint feature code corresponding to the user identification, and then match the voiceprint feature code with the voiceprint information contained in the identity verification request. If the voiceprint feature code matches with the voiceprint information successfully, and the semantic information contained in the login request matches with the verification code, the user passes identity verification and logs in successfully.

In one embodiment, the registration module 108 is further configured to establish a corresponding relationship between the voice segment extracted from a registration request and the voiceprint feature code acquired by calculation, and save the voice segment.

The voice segment input by the user at registration is saved, and when the voiceprint calculation algorithms are updated, the saved voice segment can be used for recalculation with the updated voiceprint calculation algorithms, and the voiceprint feature code corresponding to the voice segment contained in the voiceprint database is updated according to the calculation result, so that the update of the voiceprint calculation algorithms will not affect existing registration data, thereby improving the reliability of data.

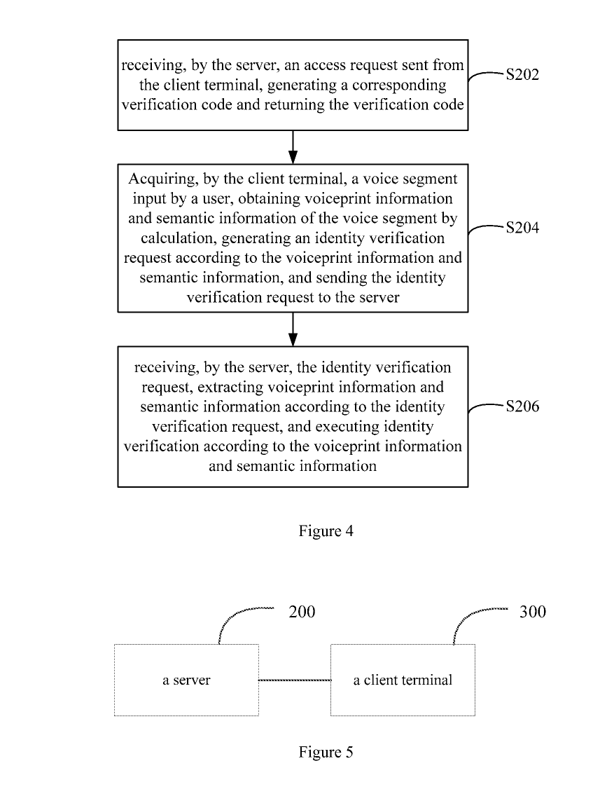

In one embodiment as shown in FIG. 4, a method for identity verification is implemented in a server and a client terminal, including:
S202, receiving, by the server, an access request sent from the client terminal, generating a corresponding verification code and returning the verification code.
S204, acquiring, by the client terminal, a voice segment input by a user, obtaining voiceprint information and semantic information of the voice segment by calculation, generating an identity verification request according to the voiceprint information and semantic information, and sending the identity verification request to the server; and
S206, receiving, by the server, the identity verification request, extracting voiceprint information and semantic information according to the identity verification request, and executing identity verification according to the voiceprint information and semantic information.

In one embodiment as shown in FIG. 5, a system for identity verification is provided, including a server 200 and a client terminal 300, wherein:
the server 200 is configured to receive an access request sent from the client terminal, then generate a corresponding verification code and returns the verification code;
the client terminal 300 acquires a voice segment input by a user, obtains voiceprint information and semantic information of the voice segment by calculation, generates an identity verification request according to the voiceprint information and semantic information, and sends the request to the server; and
the server 200 receives the identity verification request, extracts voiceprint information and semantic information according to the identity verification request, and executes identity verification according to the voiceprint information and semantic information.

According to the method, device and system for identity verification of the present disclosure, when executing identity verification, the user simply needs to dictate the content shown in the verification code in order to complete the operation of inputting, without the need of inputting a password or a verification code. As compared with the prior art solution, the present disclosure reduces the operation steps for inputting when the user executes identity verification, thereby improving operation convenience.

It should be understood by those skilled in the art that all or part of the processes of the embodiments disclosed above may be realized through relevant hardware commanded by computer program instructions. The program may be saved in a computer readable storage medium, and the program may include the processes of the preferred embodiments mentioned above when it is executed. Wherein, the storage medium may be a diskette, optical disk, ROM (Read-Only Memory) or RAM (Random Access Memory), and so on.

It should be understood by those skilled in the art that what described above are preferred embodiments of the present invention. Various modifications and replacements may be made therein without departing from the theory of the present disclosure, which should also be seen in the scope of the present disclosure.

1-16. (canceled)

17. A method for identity verification, comprising:
receiving by a computer system an access request, generating a corresponding verification code and returning the corresponding verification code;
acquiring, from the computer system, voiceprint information and semantic information corresponding to the access request, wherein the semantic information corresponds to the verification code; and
executing, by the computer system, identity verification according to the voiceprint information and semantic information.

18. The method for identity verification according to claim 17, wherein, prior to receiving access request, the method further comprises:
acquiring, by a computer system, a registration request;
extracting, by a computer system, a voice segment contained in the registration request; and
calculating, by a computer system, voiceprint feature codes of the voice segment and saving the voiceprint feature codes into a voiceprint database.

19. The method for identity verification according to claim 18, wherein, executing identity verification according to the voiceprint information and semantic information comprises:
querying the voiceprint database and determining whether there is voiceprint feature code corresponding to the voiceprint information, and determining whether the semantic information corresponds with the verification code; when the voiceprint database contains corresponding voiceprint feature code and the semantic information corresponds with the verification code, then allowing the access request to pass identity verification.

20. The method for identity verification according to claim 17, wherein, executing identity verification according to the voiceprint information and semantic information comprises:
acquiring, by a computer system, a user identification corresponding to the access request;
querying a module for an voiceprint feature code that corresponds to the user identification;
determining whether the extracted voiceprint information corresponds with the voiceprint feature code, and
determining whether the semantic information corresponds with the verification code, and both the extracted voiceprint information corresponds and the semantic information corresponds, then passing the access request identify verification.

21. A device for identity verification, comprising:
a verification code return module configured to receive an access request, generate a corresponding verification code and return the corresponding verification code;
a feature extraction module, configured to acquire voiceprint information and semantic information corresponding to the access request, and wherein the semantic information also corresponds to the verification code; and
an identity verification module, configured to execute identity verification using to the voiceprint information and semantic information.

22. The device for identity verification according to claim 21, further comprising a registration module, configured to acquire a registration request, extract a voice segment contained in the registration request, calculate voiceprint feature codes of the voice segment, and save the voiceprint feature into a voiceprint database.

23. The device for identity verification according to claim 22, wherein, the identity verification module is further configured to query the voiceprint database and determine whether there is voiceprint feature code corresponding with the voiceprint information, and configured to determine whether the semantic information corresponds with the verification code; when the voiceprint database contains the corresponding voiceprint feature code and the semantic information corresponds with the verification code, then the request passes identity verification.

24. The device for identity verification according to claim 21, further comprising a user identification acquiring module configured to acquire a user identification corresponding to the access request; and wherein the identity verification module is further configured to query for a voiceprint feature code corresponding to the user identification; determine whether the extracted voiceprint information corresponds with the voiceprint feature code, and determine whether the semantic information corresponds with the verification code, and when both determinations correspond then indicate that the access passes identity verification.

25. The device for identity verification according to claim 21, wherein, the device for identity verification is a mobile phone.

26. A method for identity verification, implemented in a server and a client terminal, comprising:
receiving, by the server, an access request sent from the client terminal, generating a corresponding verification code, and returning the verification code to the terminal;
acquiring, by the client terminal, a voice segment input by a user, obtaining voiceprint information and semantic information of the voice segment by calculation, generating an identity verification request according to the voiceprint information and semantic information, and sending the identity verification request to the server; and
receiving, by the server, the identity verification request, extracting voiceprint information and semantic information according to the identity verification request, and executing identity verification according to the voiceprint information and semantic information.

27. A system for identity verification, comprising a server and a client terminal, wherein the server is configured to receive an access request sent from the client terminal and then generate a corresponding verification code and return the verification code to the client terminal;
the client terminal is configured to acquire a voice segment input by a user, obtain voiceprint information and semantic information of the voice segment by calculation, generate an identity verification request according to the voiceprint information and semantic information, and then send the request to the server; and
the server is further configured to receive the identity verification request, extract voiceprint information and semantic information according to the identity verification request, and execute identity verification according to the voiceprint information and semantic information.

28. The method for identity verification according to claim 18, wherein, the executing identity verification according to the voiceprint information and semantic information comprises:
acquiring a user identification corresponding to the access request;
querying for an voiceprint feature code corresponding to the user identification; determining whether the extracted voiceprint information matches with the voiceprint feature code, and determining whether the semantic information matches with the verification code, and when both determination results match, then the access request passes identity verification.

29. The device for identity verification according to claim 22, further comprising a user identification acquiring module configured to acquire a user identification corresponding to the access request; and wherein the identity verification module is further configured to query for a voiceprint feature code corresponding to the user identification; determine whether the extracted voiceprint information matches with the voiceprint feature code, and determine whether the semantic information matches with the verification code, and if both determination results are matching, then the access request passes identity verification.

30. The device for identity verification according claim 22, wherein, the device for identity verification is a mobile phone.

31. The device for identity verification according to claim 23, wherein, the device for identity verification is a mobile phone.

32. The device for identity verification according to claim 24, wherein, the device for identity verification is a mobile phone.
